(19) United States
(12) Patent Application Publication
(10) Pub. No.: US 2009/0100638 A1
(43) Pub. Date: Apr. 23, 2009

(54) Stand hinge for display

(75) Inventor: Yung-Sheng Lin, Taipei County (TW)

Correspondence Address: Joe McKinney Muncy, PO Box 1364, Fairfax, VA, 22038-1364, US

(73) Assignee: Taiwan Thick-Film Ind. Corp.

(21) Appl. No.: 11/976,283

(22) Filed: Oct. 23, 2007

(51) Int. Cl. E05D 7/00

(52) U.S. Cl. 16/221

(57) ABSTRACT

The present invention includes a carrying frame with two connecting ends for pivotally connected to a supporting frame for mounting the display, and two pivots are respectively mounted at the positions where the connecting ends of the carrying frame are pivotally connected with the supporting frame, wherein one pivot is penetrated through a hook flange washer and a positioning flange washer, wherein the hook flange washer has plural protruding portions located at one side of the edge thereof, and the positioning flange washer correspondingly has plural bulges located at one side of the edge thereof for forming a position-limiting trough to reject with the protruding portion, and the other pivot is penetrated through plural positioning washers and at least a plate type washer, so that when the carrying frame has a turning, the required torsion can be provided by the rejection between the protruding portion and the position-limiting trough.

### FIELD OF THE INVENTION

The present invention is related to a stand hinge for display, and more particularly to a stand hinge for display which can maintain the torque balance as adjusting the angle of the display.

### BACKGROUND OF THE INVENTION

Nowadays, owing to the modern life style, the visual or image device becomes lighter and thinner, so that the flat panel display, which is developed by cooperating optoelectronics technology with semiconductor manufacturing technology, such as LCD, OLED and PDP, has already become the mainstream display product. And, since the screen size of the display is growing, the supporting structure thereof is also increasingly emphasized.

For adjusting the view angle of the display according to different user's habit, as the conventional technology shown in FIG. 1, a stand hinge for display capable of adjusting the view angle of the display is disclosed which includes a carrying frame 100, a support frame 200 and a pivot 30. The carrying frame 100 is pivotally connected to the supporting frame through the pivot 30, so that the carrying frame 100 is capable of producing a turning stroke related to the supporting frame 200, and thus, the view angle of the display can be adjusted. Further, the pivot 30 is penetrated through a torsional spring 60 so as to provide the torsion needed by the turning carrying frame 100. However, this conventional stand hinge for display still has some disadvantages as follows:

1. It is not easy and also costs time to assemble the torsional spring 60, so that the production efficiency might be reduced.

2. After long-term usage, the torsional spring 60 might easily fall off so as to cause unbalanced torsion, and thus, the display can not be supported normally.

Moreover, another improvement for solving the defects described above is disclosed, such as R.O.C. Patent NO. M247671 entitled “Reciprocating Hinge” applied by the applicant. This patent includes a fixing base with a penetrating hole, and a turning element disposed in the penetrating hole, wherein the turning element has, mounted thereon, plural washers, a fixing piece, a turning piece and a fixing element, and the washers, the fixing piece and the turning piece are fixedly locked on the turning element through the fixing element. The fixing piece and the turning piece respectively have a through hole and a linking hole located at the center thereof, and the linking hole is driven by the turning element. Further, the fixing piece and the turning piece also respectively have a position-limiting portion and a position-limiting trough mounted thereon, wherein the position-limiting portion is located at the circular edge of the fixing piece and the position-limiting trough is located at the circular edge of the turning piece, and the position-limiting portion and the position-limiting trough are engaged with each other. Although this technology solves the defects described above, it still has some disadvantages, for example, when the position-limiting portion of the fixing piece comes off the position-limiting trough of the turning piece, then the turning of the turning piece has to be performed through rejecting the side surface thereof to the position-limiting portion, which might easily cause the turning piece and the fixing piece to produce too much torsion in one single direction, thereby resulting in an unbalanced display support.

### SUMMARY OF THE INVENTION

The main object of the present invention is to provide a stand hinge for display which not only saves the assembling time and cost, but also can provide sufficient torsion for balance as adjusting the angle of the display.

For achieving the object described above, the present invention provides a stand hinge for display including a carrying frame for mounting a display, and the carrying frame has two connecting ends for pivotally connected to a supporting frame, and two pivots are respectively mounted at the positions where the connecting ends of the carrying frame are pivotally connected with the supporting frame. One pivot is penetrated through a hook flange washer and a positioning flange washer, wherein the hook flange washer has plural protruding portions located at one side of the edge thereof, and the positioning flange washer correspondingly has plural bulges located at one side of the edge thereof for forming a position-limiting trough to reject with the protruding portion. Besides, the other pivot is penetrated through plural positioning washers and at least a plate type washer. Therefore, when the carrying frame has a turning related to the supporting frame, the required torsion can be provided by the rejection between the protruding portion and the position-limiting trough, and through the corresponding side surfaces of the hook flange washer and the positioning flange washer being normally maintained in a parallel rejection without coming off, a balancing torsion for the turning display can be provided.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the appearance of a conventional stand hinge for display;

FIG. 2 is a schematic view showing the appearance of the present invention;

FIGS. 3A˜3B are decomposition drawings showing the structure of the present invention;

FIG. 4 is a schematic view showing a partial decomposition of the present invention;

FIGS. 5A˜5B are schematic views showing continuous movements of the present invention; and

FIGS. 6A˜6B are schematic views showing the view angle adjustment in an embodiment of the present invention.

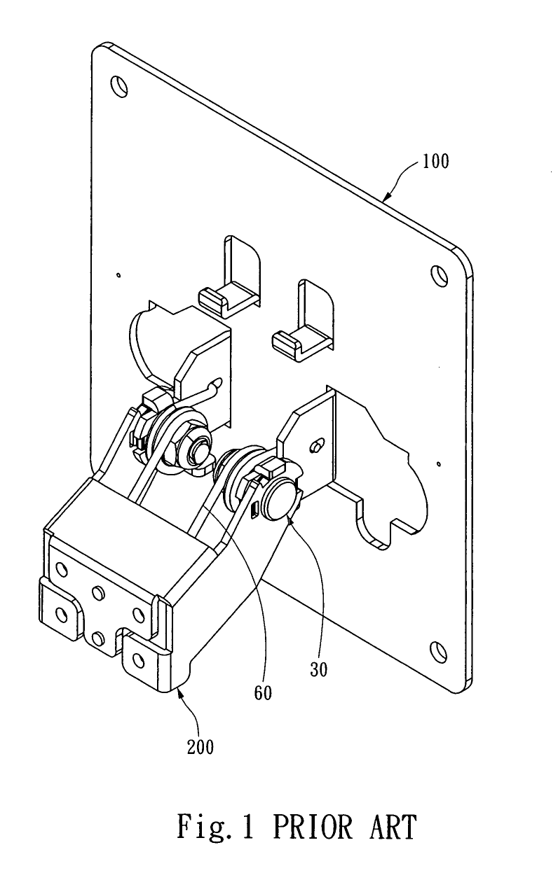

### DESCRIPTION OF THE PREFERRED EMBODIMENT

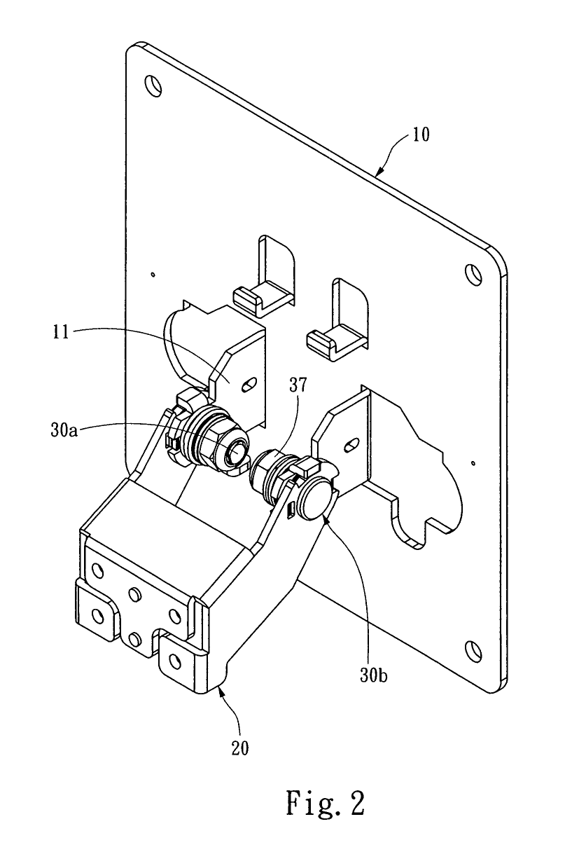

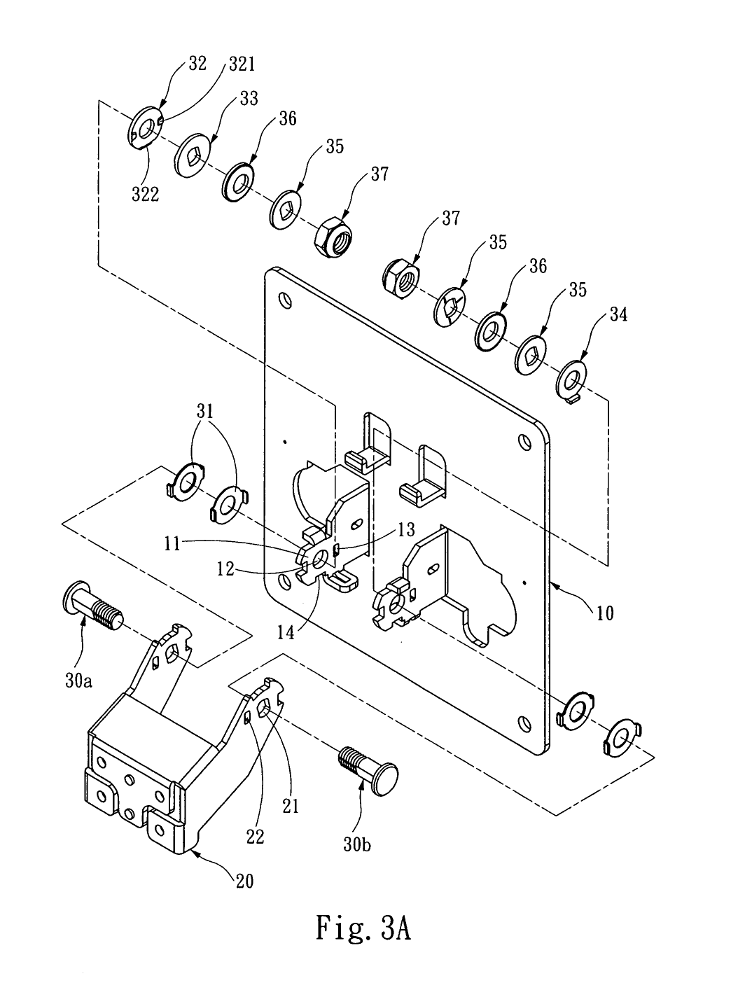

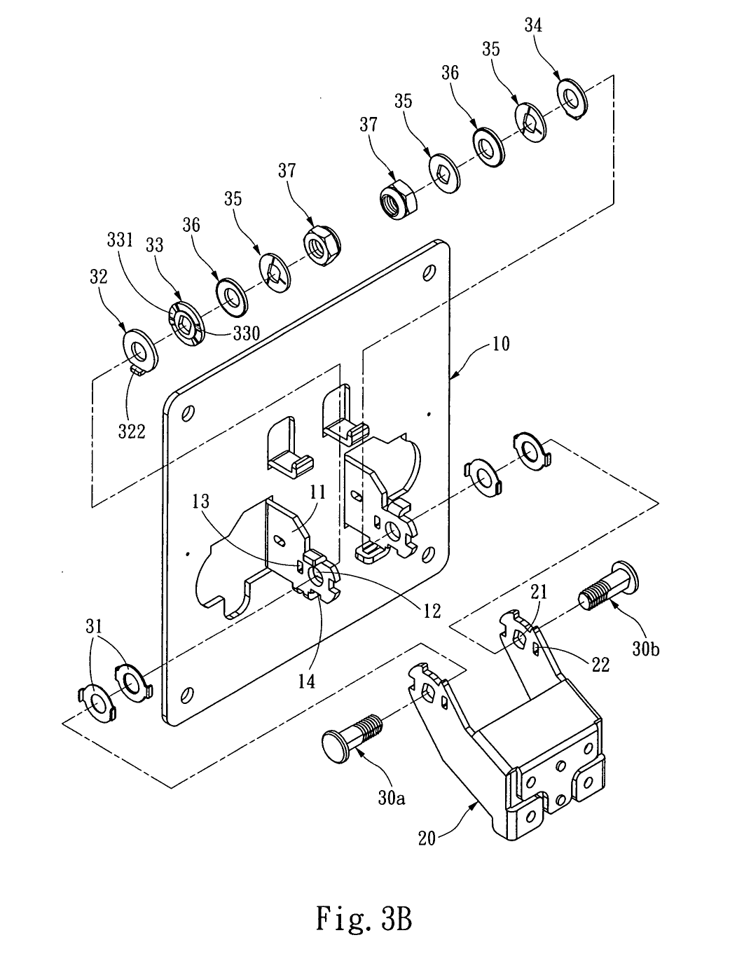

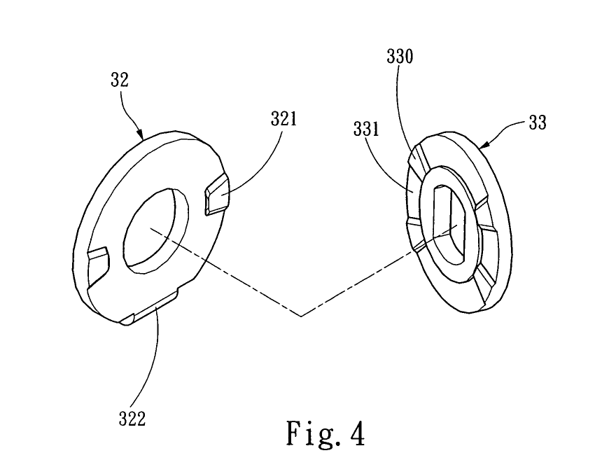

Please refer to FIG. 2, FIGS. 3A˜3B and FIG. 4. The stand hinge for display of the present invention at least includes a carrying frame 10 for mounting a display 40, a supporting frame 20 for supporting the carrying frame 10, and two pivots 30a, 30b pivotally connected to the carrying frame 10 and the supporting frame 20. The carrying frame 10 has two connecting ends 11 and each the two connecting ends 11 has an axial hole 12 for corresponding to two linking holes 21 mounted on the supporting frame 20. The two pivots 30a, 30b are penetrated through the axial holes 12 and the linking holes 21 for pivotally connecting the carrying frame 10 with the supporting frame 20, so that the carrying frame 10 can produce a turning stroke related to the supporting frame 20. Moreover, the pivots 30a, 30b are further penetrated through two dual-hook washers 31, which are located between the carrying frame 10 and the supporting frame 20, and the dual-hook washers 31 are respectively mounted on plural positioning holes 13, 22 of the connecting end 11 and the supporting frame 20. And, one pivot 30a is sequentially penetrated through a hook flange washer 32, a positioning flange washer 33, a plate-type washer 36 and a positioning washer 35, wherein the hook flange washer 32 has a protruding portion 321 located at one side of the edge thereof, and the positioning flange washer 33 has plural bulges 330 located at one side of the edge thereof, so as to form a position-limiting trough 331 to reject with the protruding portion 321. The connecting end 11 and the hook flange washer 32 respectively have an assembling trough 14 and an assembling block 322, which are engaged with each other. The positioning flange washer 33 has an inner diameter equal to the outer diameter of the pivot 30a, so that the positioning flange washer 33 can be driven by the pivot 30a. The other pivot 30b is penetrated through a uni-hook washer 34, plural positioning washers 35 and a plate type washer 36 which are located between two axial holes 12, and the plate type washer 36 is located between plural positioning washers 35. Furthermore, the two pivots 30a, 30b respectively have a nut 37 mounted at the ends thereof for stabilizing the washers, wherein the inner diameter of the positioning washers 35 is equal to the outer diameter of the pivots 30a, 30b, so that the positioning washers 35 can have synchronous movement with the pivots 30a, 30b. Thereby, a stand hinge for display for providing balanced torsion is completed.

When assembling, first, each the dual-hook washers 31 is mounted on the positioning holes 13, 22 of the carrying frame 10 and the supporting frame 20, second, the axial hole 12 of the carrying frame 10 is aimed at the linking hole 21 of the supporting frame 20, then, the pivot 30b penetrates the axial hole 12, the linking hole 21 and sequentially the uni-hook washer 34, the positioning washers 35 and the plate type washer 36, in which the plate type washer 36 is located between the positioning washers 35, and finally, the nut 37 is screwed at the end of the pivot 30b for providing adjustable tightness. Moreover, the other pivot 30a penetrates the axial hole 12 and the linking hole 21 at the other side, and also, sequentially, the hook flange washer 32, the positioning flange washer 33, the plate type washer 36 and the positioning washer 35, and then, another nut 37 is screwed at the end of the pivot 30a for providing adjustable tightness. Thereby, the assembling is completed.

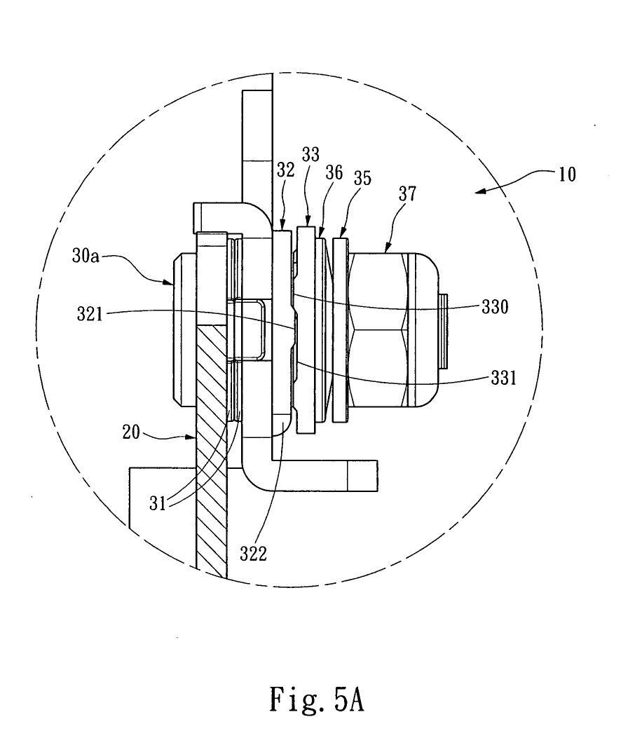

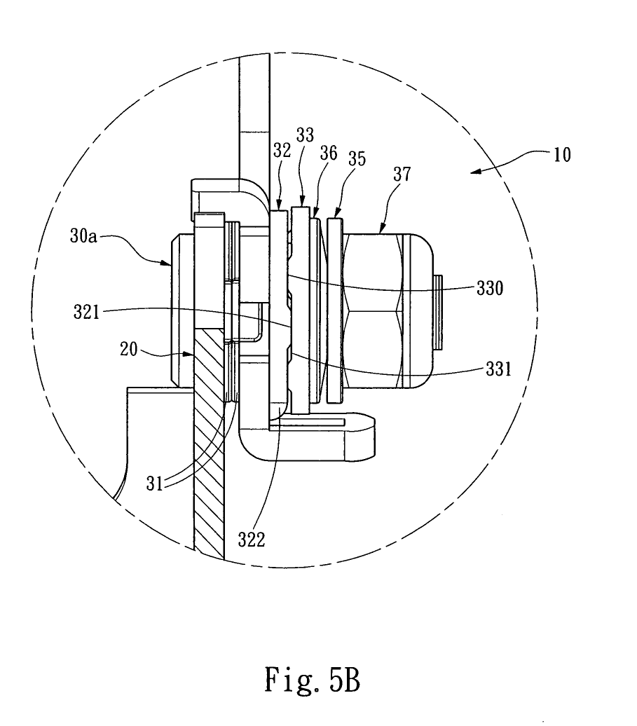

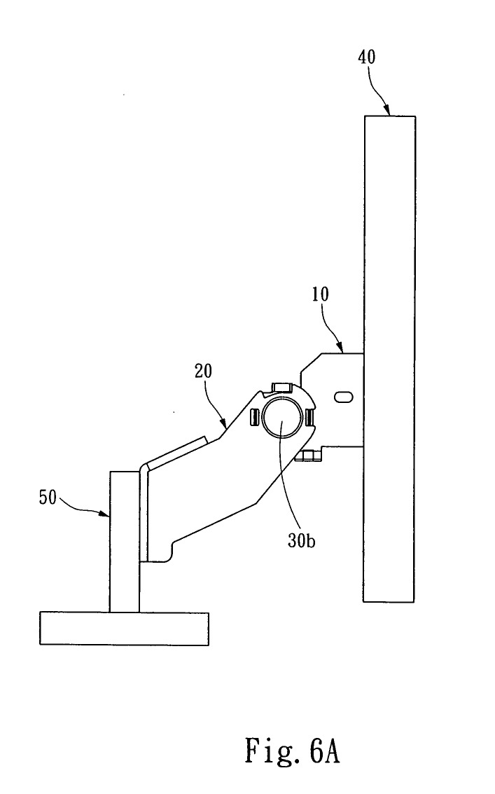

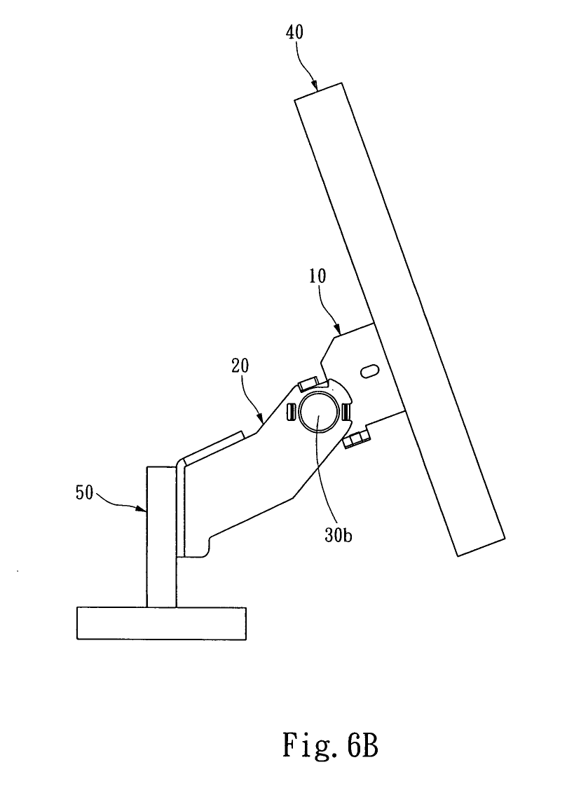

Please refer to FIG. 5A˜5B and FIGS. 6A˜6B. The carrying frame 10 of the present invention is mounted thereon a display 40, and the supporting frame 20 is connected to a base 50 for locating the display on a table. Therefore, when the display 40 is under an erect state with 90 degree (as shown in FIG. 6A) or is leaning forward, the hook flange washer 32 and the positioning flange washer 33 will be rejected with each other, so that the protruding portion 321 will be engaged with the position-limiting trough 331 for rejecting to the bulge 330 so as to form a position-limiting relationship (as shown in FIG. 5A), and thus, the display 40 will not fall down even the weight of the display 40 exceeds the torsion provided by the pivot 30a and plural washers penetrated thereby. When the display 40 is forced for adjusting to face upward, the display 40 and the carrying frame 10 can have a turning related to the supporting frame 20, so that the protruding portion 321 of the hook flange washer 32 will come off the bulge 330 of the positioning flange washer 33 to release the position-limiting relationship and also will slide in the position-limiting trough 331 (as shown in FIG. 5B). At this time, the pivot 30b and plural washers penetrated thereby (as shown in FIG. 2) can provide the torsion required by the display 40 for turning upward. When the protruding portion 321 slides in the position-limiting trough 331 and moves to another bulge 330 of the positioning flange washer 33, the display 40 may have a 20 degree upward angle (as shown in FIG. 6B), and through the protruding portion 321 of the hook flange washer 32 rejecting to the side surface of the positioning flange washer 33 and the bulge 330 of the positioning flange washer 33 rejecting to the side surface of the hook flange washer 32, the hook flange washer 32 and the positioning flange washer 33 can normally be maintained in a parallel rejection without coming off, so as to provide the torsion for balancing the turning display 40. Through the implementation described above, the stand hinge for display of the present invention has the advantages that:

1. Compared with the conventional technology which utilizes torsional spring to provide torsion, the present invention can reduce not only installation complexity but also installation time.

2. The hook flange washer 32 and the positioning flange washer 33 of the present invention only need to be mounted at one side of the carrying frame 10 for providing the torsion required in turning, so that the production cost can be saved.

3. The corresponding side surfaces of the hook flange washer 32 and the positioning flange washer 33 can normally be maintained in a parallel rejection without coming off for providing a balancing torsion to the turning display 40.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stand hinge for display for enabling a view angle adjustment of a display, comprising:
a carrying frame, for mounting the display and having two connecting ends;
a supporting frame, pivotally connected to the connecting ends of the carrying frame; and
two pivots, respectively mounted at the positions where the connecting ends of the carrying frame are pivotally connected with the supporting frame, wherein
one pivot is penetrated through a hook flange washer and a positioning flange washer, wherein the hook flange washer has plural protruding portions located at one side of the edge thereof, and the positioning flange washer correspondingly has plural bulges located at one side of the edge thereof for forming a position-limiting trough to reject with the protruding portion; and
the other pivot is penetrated through plural positioning washers and at least a plate type washer.

2. The stand hinge for display as claimed in claim 1, wherein the connecting end has plural positioning holes for supporting a dual-hook washer.

3. The stand hinge for display as claimed in claim 1, wherein the supporting frame has plural positioning holes for mounting a dual-hook washer.

4. The stand hinge for display as claimed in claim 1, wherein the connecting end has an assembling trough and the hook flange washer correspondingly has an assembling block.

5. The stand hinge for display as claimed in claim 1, wherein the inner diameter of the positioning flange washer is equal to the outer diameter of the pivot.

6. The stand hinge for display as claimed in claim 1, wherein the plate type washer is located between plural positioning washers.

7. The stand hinge for display as claimed in claim 1, wherein the inner diameter of the positioning washers is equal to the outer diameter of the pivots.

8. The stand hinge for display as claimed in claim 1, wherein the connecting ends and the supporting frame respectively have axial holes and linking holes.

9. The stand hinge for display as claimed in claim 1, wherein the end of the pivot is screwed by a nut.
